(19) United States
(12) Patent Application Publication
(10) Pub. No.: US 2004/0129755 A1
(43) Pub. Date: Jul. 8, 2004

(54) Wire bonding capillary

(75) Inventor: Eran Macover, Givat Ella (IL)

Correspondence Address: DR. MARK FRIEDMAN LTD., C/o Bill Polkinghorn, Discovery Dispatch, 9003 Florin Way, Upper Marlboro, MD, 20772, US

(73) Assignee: KESSEM TRADE COMPANY LTD

(21) Appl. No.: 10/740,634

(22) Filed: Dec. 22, 2003

Related U.S. Application Data
(62) Division of application No. 10/083,588, filed on Feb. 27, 2002.
Application No. 10/083,588 is a continuation-in-part of application No. 09/534,970, filed on Mar. 27, 2000, now abandoned.

(51) Int. Cl. B23K 37/00; B23K 31/02

(52) U.S. Cl. 228/4.5; 228/180.5

(57) ABSTRACT

A wire bonding capillary having an extended service life-time, the use of which results in bonds with improved and stable qualities. The capillary includes a polymeric film which is vapor phase polymerized on the out side of the capillary tip in which a threaded bond wire travels. The polymeric film prevents bond deterioration and capillary clogging by a layer of contaminates which originate from the wire and the capillary manufacturing processes, and which would otherwise accumulate inside the bore and on the face of the tip of the capillary.

This is a Divisional of U.S. patent application Ser. No. 10/083,588, pending, which is a Continuation-In-Part of U.S. patent application Ser. No. 09/534,970 filed Mar. 27, 2000, now abandoned.

### FIELD AND BACKGROUND OF THE INVENTION

The present invention relates to a method and an apparatus for mounting a semiconductor device onto a lead-frame, and more particularly to an improved wire bonding capillary provided for a wire bonding apparatus and a method of forming electric connection contacts which electrically connect metal bond pads formed on a semiconductor die to the lead fingers of a lead frame.

Wire bonding devices are well known in the art. U.S. Pat. No. 3,894,671 issued to Kulicke Jr., et al., U.S. Pat. No. 4,877,173 issued to Fujimoro, et al., and U.S. Pat. No. 5,082,154 issued to Ishizuka illustrate known bonding devices.

The wire bonding process occurs during the final stages of manufacture when the semiconductor device is enclosed within a sealed package. Although a variety of different packaging systems are used in the semiconductor industry, most systems include a lead-frame on which the die is mounted, lead-fingers and bond wires electrically connecting the lead fingers to a metal bond pad on the die, and a sealed package enclosing the various components. Initially, numerous dies are usually mounted on the lead-frame.

The metal bond pads formed on the surface of each die are connected to the lead-fingers on the lead-frame using a very thin wire. The dies are then enclosed within a sealed package. A portion of the lead-fingers extends out through the package for connection to an external circuit. A trim and form operation is used to separate each die package and to bend the protruding lead-fingers into the proper configuration.

During the wire bonding process, a heat block heats the die and the lead-frame to a temperature of about 150° C. to 350° C.

The bond wire is threaded through the bonding capillary, and the end of the wire is then heated by an electrical discharge or a hydrogen torch to a molten state, thus forming a ball of molten metal on the end of the bond wire. The molten ball is mechanically pressed by the bonding capillary against the heated bond pad, sometimes in combination with ultrasonic vibration, to weld the metallic elements of the wire and the metal bond pad and thereby bond the wire to the pad.

The bonding capillary tool is then moved to a bonding site on the appropriate lead finger. The wire is pressed against the heated lead finger to bond the wire to the lead finger.

The bond wire is then tensioned and sheared. This process is repeated for each bond pad on the die. The stages of this process are shown schematically in FIGS. 1(a) through 1(g) to which reference will be made hereafter.

A strong demand for advanced and sophisticated wire bonding applications exists, in which the number of electrode pads per die is increased, the pitch of the connecting terminals is shortened, and the overall robustness of the wire bonding process is reliable and effective.

The design and dimension of the capillary play a significant role on the bond characteristics. Over the years, the constant push for smaller pad pitches has driven the capillary vendors to develop capillaries with smaller capillary dimensions.

A general rule of thumb for one is to estimate the capillary tip size as 1.3 times the pad pitch. Thus e.g., a 70 μm pitch process would require a 90 μm capillary tip size in which the typical whole diameter for this pitch is 30 μm and in which a 25 μm bonding wire is threaded.

The clearance between the sidewalls of the bore of the capillary and the bond wire, controls the friction force as the wire moves in the bore. When this clearance becomes too tight, the drag force of the wire in the capillary increases until the capillary becomes clogged.

At this stage the capillary ends its life span and has to be replaced. This is a costly process, and also causes delays in the IC's production lines.

In order to reduce the above-mentioned friction, the capillaries, which are made of alumina of fine homogenous microstructure (which yields in a very smooth surface), employ highly polished bores. Even so, conventional capillaries have a life span of only about 500 Kwire (10⁶ hits).

Recently, wear resistant capillaries were introduced. These capillaries, which have a unique ceramic coating inside the bore, are designed to work for longer time with hard Ni-Pd bond wires, which erode the bore of conventional capillaries. However, even these capillaries do not provide a solution to the clogging problem when softer bond wires such as gold or aluminum are used.

Another problem with existing capillaries is that after certain service time, even before the end of their life span, the face of the capillary tip, which presses the wire or the molten ball against the finger lead or against the pad respectively, becomes contaminated with an accumulated layer of material which is much softer then alumina. This phenomenon, which occurs prior to the clogging of the capillary, yields already at earlier stages bonds with inferior properties.

There is therefore a widely recognized need for a capillary that would overcome the disadvantages of presently known capillaries as described above.

### SUMMARY OF THE INVENTION

The present invention provides a capillary for ball or wedge bonding with extended life span compared to prior art capillaries, which provides ball bonds with improved and stable qualities.

The present invention provides a wire bonding capillary comprising a capillary tip having a face for pressing a metal wire against an electrode pad, wherein at least a part of the face of the capillary tip are coated with a layer of polymeric material.

In accordance with the present invention there is provided a wire bonding capillary for pressing a metal wire against an electrode pad comprising a capillary tip having a pressing face, wherein at least a part of the pressing face of the capillary tip is coated with a layer of polymeric material, said polymeric material including at least one thermoplastic polymer.

In accordance with the present invention there is provided a method for preparing a wire bonding capillary comprising the steps of: (a) providing a wire bonding capillary which comprises a capillary tip having a face for pressing a metal wire against an electrode pad comprising a capillary tip having a pressing face; and, (b) coating at least part of said pressing face of said capillary tip with a layer of polymeric material, said polymeric material including at least one thermoplastic polymer.

It is therefore an object of the present invention to provide a wire-bonding capillary with increased service life, which will reduce bonder down time.

It is another object of the present invention to provide bonds with improved qualities.

It is yet another object of the present invention to provide bonds with stable qualities.

Other objects of the invention will become apparent upon reading the following description taken in conjunction with the accompanying drawings.

### BRIEF DESCRIPTION OF THE DRAWINGS

FIGS. 1(a)-1(g) show the steps of conventional prior art wire bonding technique.

FIG. 2 is a sectional view of an embodiment of a wire bonding capillary according to the present invention.

FIGS. 3(a)-3(d) show test results for bonds produced with the capillary according to the present invention.

### DETAILED DESCRIPTION OF THE EMBODIMENTS

The present embodiment herein is not intended to be exhaustive and to limit in any way the scope of the invention, rather it is used as examples for the clarification of the invention and for enabling of other skilled in the art to utilize its teaching.

The present invention describes an improved capillary for wire bonding (either ball or wedge bonding).

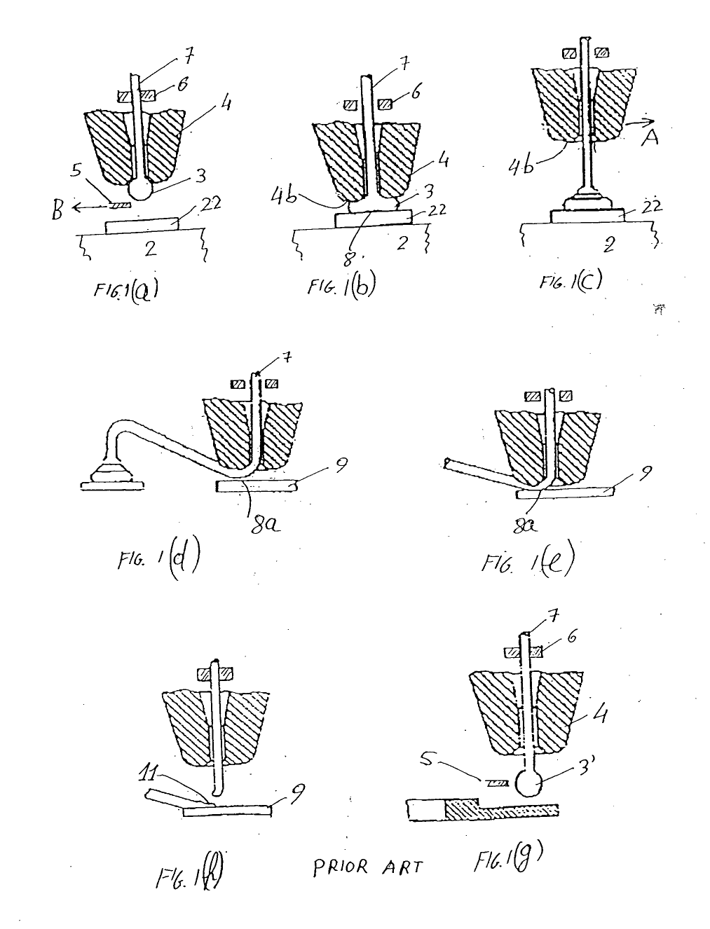

Wire bonding is a prior art technique which include the following stages: First, as shown in FIG. 1(a), a capillary 4, through which bonding wire 7 is threaded, is targeted over a the die 2 and positioned above bond pad 22. At this stage wire clamps 6 are closed. A ball 3 is formed by a spark discharge created by an electric torch 5 on part of wire 7, which extends from the lower end of a capillary 4. Electric torch 5 is there moved aside in the direction shown by arrow B.

Next, as shown in FIG. 1(b), the wire clamps 6 open and the capillary 4 is lowered. The ball 3 on the tip end of the wire 7 is pressed against the first bonding area 8 by the face 4b of the tip of capillary 4, and an ultrasonic vibration is applied to the capillary tip 4 by a horn (not shown), so as to bond the ball 3 to the first bonding area 8.

Afterward, as shown in FIG. 1(c), capillary 4 is raised and moved in direction A, so as to be positioned at a point above the second bonding. Next, as shown in FIG. 1(d), the capillary 4 is lowered toward a second contact point 8a on a lead finger 9 and wire 7 is crushed against the second bonding point 8a, as shown in FIG. 1(e). An ultrasonic vibration is applied to the capillary 4 by the horn (not shown), so as to bond the wire 7 to the second bonding point 8a.

Then, as shown in FIG. 1(f), the capillary 4 is raised off the bonding point. The clamps 6, which move together with the capillary, are closed at a pre-set height. This prevents the wire from feeding out the capillary and pulls at the bond.

The wire detaches at its thinnest cross section which was already weakened, near the stitch 11 as shown in FIG. 1(f).

A new ball 3′ is formed again by an electronic torch 5 on the tail of the wire 7 which extends from the end of the capillary 4 as shown in FIG. 1(g). The cycle is thus completed and ready for the next ball bond.

This sequence of stages demonstrates the active role, that face 4b of capillary 4, has in the wire bonding process.

During a life span of a capillary, it may lead through it several hundred meters of threaded bond wire, as a result, there exist mutual wearing of the capillary and the bonding wire at their contact area, the extent of which depends on the relative hardness of the capillary surface and the bonding wire.

Because the capillary is made of alumina, or other hardened ceramic materials, some of the constituents on the outer surface of the soft gold or aluminum wires will be smeared on the faces of the capillary which are in contact with the wires, namely the sidewalls of the bore of the capillary and the pressing surface of the capillary tip.

The outer surface of the bond wire includes contaminates, which consist of residues of lubricating materials and of other materials, which are used in the manufacturing of the bond wires or capillary.

This is so because wires that are usually made of gold or of aluminum, are manufactured by extrusion processes by which they are pulled through orifices of decreasing diameter, and in order to enable the wire manufacturing process, special lubricating material are used, which adhere to the surface of the wire and are not completely removed even after the final cleaning of the wire.

Part of these depositions is smeared over the surface of the bore of the capillary during the travel of the bonding wire in it. Other part of these contaminants adheres to the surface of the face of the tip of capillary.

Besides, during their manufacturing the capillaries themselves are subjected to polishing process, these processes can leave some organic sludge residues on the alumina surface of the capillary, which contribute as well to the contamination of the face of the capillary.

During bonding in general, and during ball bonding in particular, both the capillary and the wire get heated. This causes the polymerization and oxidation of these residues, which are then converted into a solid a buffer layer, separating between the hard alumina pressing surface of the face of the capillary tip and the wire. This buffer layer prevents the correct application of the bonding force by the capillary while the bond is being formed which results with bonds having inconsistent quality.

The present invention discloses a method for the reduction of the amount of contamination that is delivered from the outer surface of the bond wire to the surface area of the capillary which is in contact with the bond wire, extending by this the working time period of the capillary and improves the ball bond and the stitch qualities at all the stages of its service life.

The method includes the covering of the active alumina surface of the capillary, which is in contact with the bond wire, with an inert surface, which rejects accumulation of contaminates, particularly on the face of the capillary which presses the bond wire.

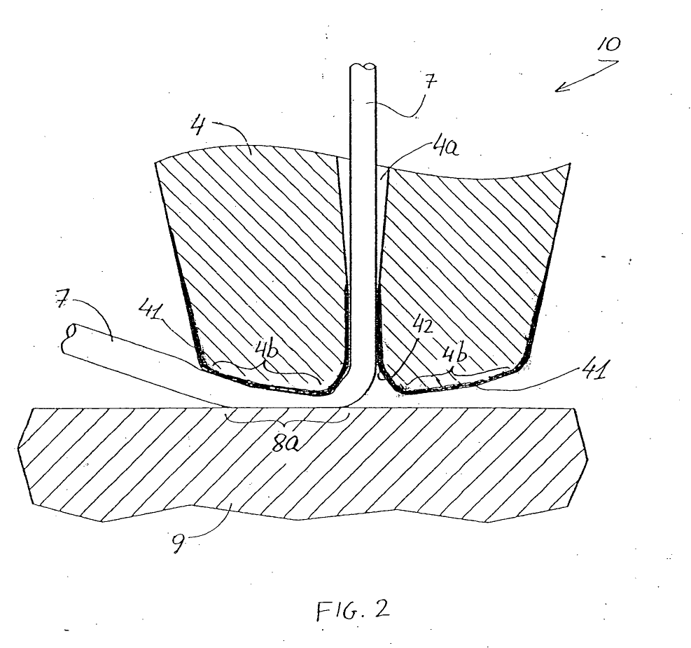

FIG. 2 shows an embodiment 10, of the present invention. It includes coating the outer surface of the tip of the capillary 4 with a layer 41 of deposited polymer having thickness of 0.3-8 μm. It is a long lasting layer which prevents the adherence of organic contaminates originating from bonding wire 7 and other sources as described above, on surface of the pressing face 4b of the tip of capillary 4.

Polymer layer 41 deposited inside bore 4a, does not affect wire 7 travel along the capillary bore 4a, even at the narrow “bottle neck” 42, of the capillary in which the clearance between the 7 and sidewalls of bore 44 surface is minimal.

In embodiment 10 of the invention, the polymer film 41 includes the compound with the generic name-“parylene” (poly-para-xylylene), a thermoplastic film polymer, which is deposited on the outer surface of capillary 4 by the process of vapor-phase-polymerization.

The coating of objects with films of “parylene” by vapor-phase-polymerization is a known process whose description is documented, e.g., in pages 1323-1330 of “Concise Encyclopedia of Polymer Science and Engineering”, Jacqueline I. Kroschwitz, executive editor, John Wiley & Sons Inc. 1990.

The polymer deposition procedure was applied to wire bonding capillaries, which after being thoroughly clean washed and dried, were introduced into the deposition chamber of a vapor-phase-polymerization system.

The performance of capillaries according to the present invention was compared to that of reference capillaries, which were identical capillaries without a polymer film.

Both type of capillaries were employed in a commercial wire bonder and the resulting bonds were tested using standard test devices.

It was found in these tests that the properties of the bonds obtained with the capillaries of the present invention, in both the ball bonding and the wedge bonding processes, were superior to the properties of the bonds of the reference capillaries with regard to all the test parameters.

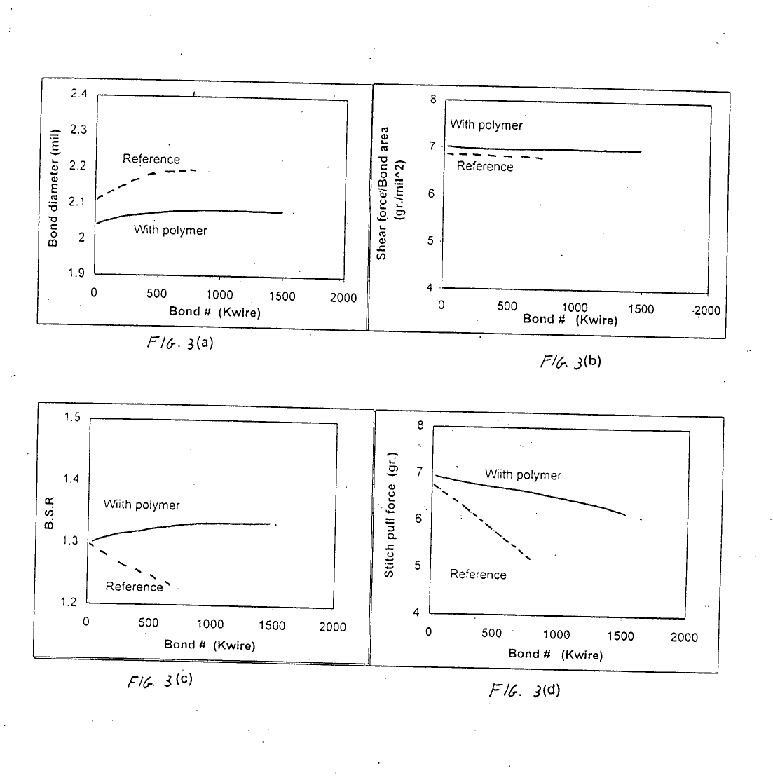

FIG. 3(a) compares the ball diameter of the bonds which were obtained by the capillary according to the present invention to the ball diameter of the ball bonds which were obtained by the untreated reference capillary. FIG. 3(b) compares the shear force per unit area of the ball bonds which were obtained by the capillary according to the present invention, to the shear force per unit area of the bonds which were produced by the untreated reference capillaries.

FIG. 3(c) compares the B.S.R, (which is the ball to wire size ratio), of the balls which were obtained by the capillary according to the present invention, to the B.S.R of balls which were produced by the untreated reference capillaries, and FIG. 3(d) compares the stitch pull force of the wedge bonds which were obtained by the capillary according to the present invention, to the stitch pull force of the wedge bonds which were produced by the untreated reference capillaries.

According to the findings presented in FIG. 3, the present invention increases the life span of capillaries from 0.7 [Mwire] to 1.4 [Mwire]. The bond quality obtained by the capillaries according to the present invention was superior to the bond quality obtained by the reference untreated capillaries (the bonds are smaller and stronger), and this improved quality was maintained throughout their whole life span, without the need for changing of the wire bonding process parameters, in contrast to existing capillaries which show deterioration in bond quality at an early stage of 0.4 [Mwire].

While the invention has been described with respect to a single embodiment, it will be appreciated that many variations, modifications and other applications of the invention may be made.

What is claimed is:

1. A wire bonding capillary for pressing a metal wire against an electrode pad comprising:
a capillary tip having a pressing face, wherein at least a part of the pressing face of the capillary tip is coated with a layer of polymeric material, said polymeric material including at least one thermoplastic polymer.

2. The wire bonding capillary as in claim 1 wherein said thermoplastic polymer is poly-p-xylylene.

3. A wire bonding capillary, for pressing a metal wire against an electrode pad, having a life span of at least 1.4 Mwire.
